(19) United States
(12) Patent Application Publication
(10) Pub. No.: US 2010/0147099 A1
(43) Pub. Date: Jun. 17, 2010

(54) DEVICE FOR CONTROLLING MACHINES AND VEHICLES

(75) Inventors: Rainer Maurer, Berlin (DE); Christian Bartenwerfer, Berlin (DE); Henning Koschke, Berlin (DE); Michael Stoffers, Berlin (DE); Thomas Goebelt, Birkenwerder (DE)

Correspondence Address: PEPPER HAMILTON LLP, ONE MELLON CENTER, 50TH FLOOR, 500 GRANT STREET, PITTSBURGH, PA, 15219, US

(73) Assignee: COACTIVE TECHNOLOGIES, INC., Newton, MA (US)

(21) Appl. No.: 12/638,467

(22) Filed: Dec. 15, 2009

(30) Foreign Application Priority Data
Dec. 15, 2008 (DE) 10 2008 063 238.4

(51) Int. Cl. G05G 1/00

(52) U.S. Cl. 74/491

(57) ABSTRACT

A control device for controlling a machine or similar vehicle. The control device includes a control lever, a fixed console upon which the control lever is movably mounted about at least two intersecting axes, a plurality of crossing holders mounted to the fixed console, each crossing holder having a longitudinal slit for guiding the control lever, and a mechanical device having force modifying points configured to be detected by tactile means during any movement of the control lever, wherein the mechanical device is positioned between the fixed console and the crossing holders, and above an installing plane of the fixed console, and wherein the intersecting axes of the crossing holders pass below an installation plane of the fixed console.

### RELATED APPLICATION AND CLAIM OF PRIORITY

This application claims priority to German Patent Application No. 10 2008 063 238.4 filed Dec. 15, 2008, which is hereby incorporated by reference in its entirety.

### Not Applicable

### BACKGROUND

The present disclosure relates to a device for controlling machines and vehicles, more particularly, to a device for controlling construction machines, cranes, agricultural vehicles and other similar machines and vehicles.

As shown in German Patent Publication DE 103 45 397 A1, the contents of which are hereby incorporated by reference, a locking device is associated with a control lever in each one of two directions the control lever can move in. The locking device includes an electromagnet that achieves a locking position by means of an external control. For this purpose, any position related data from the control lever must be evaluated accordingly, such that the electromagnet can be activated in a desired position. The control lever is locked in such a way that additional movement becomes possible only after deactivating or switching off the electromagnet. Here, the electromagnets are arranged laterally outside the holder, which leads to a considerable increase in the footprint of the fixed console.

Another disadvantage is that the control lever can be locked in a certain position only by means of an additional control. In such devices, the control lever is reset by a variety of springs configured to return the control lever to a defined zero position. To provide further assistance to the operator, tactile feedback is implemented on the respective operating path. Such tactile feedback makes it easier for the user to operate with constant deflection, or deflection to a certain position. This combination of feedback and deflection results in a constant output signal from the control lever. In cranes, for example, this is used to maintain, in a simple way, a constant work rate for the respective functions during operation. However, implementation of the feedback and deflection results in a complex design for the control lever, and generally requires a large footprint for the fixed console housing the control lever components.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “coil” is a reference to one or more coils and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

In one general respect, the embodiments disclose a control device including a control lever, a fixed console upon which the control lever is movably mounted about at least two intersecting axes, a plurality of crossing holders mounted to the fixed console, each crossing holder having a longitudinal slit for guiding the control lever, and a mechanical device having force modifying points configured to be detected by tactile means during any movement of the control lever, wherein the mechanical device is positioned between the fixed console and the crossing holders, and above an installing plane of the fixed console, and wherein the intersecting axes of the crossing holders pass below an installation plane of the fixed console.

### BRIEF DESCRIPTION OF THE DRAWINGS

Additional details of the invention can be obtained in the description below, in which the invention is described and explained in greater detail in reference to embodiment examples represented in the figures. In the figures:

FIG. 1 illustrates a schematic perspective representation of an exemplary device for controlling machines and vehicles according to an embodiment;

FIG. 2 illustrates an enlarged representation of a cross section along the line II-II of FIG. 1, and

FIG. 3 illustrates a bottom view of the exemplary device along the arrow III of FIG. 1.

### DETAILED DESCRIPTION

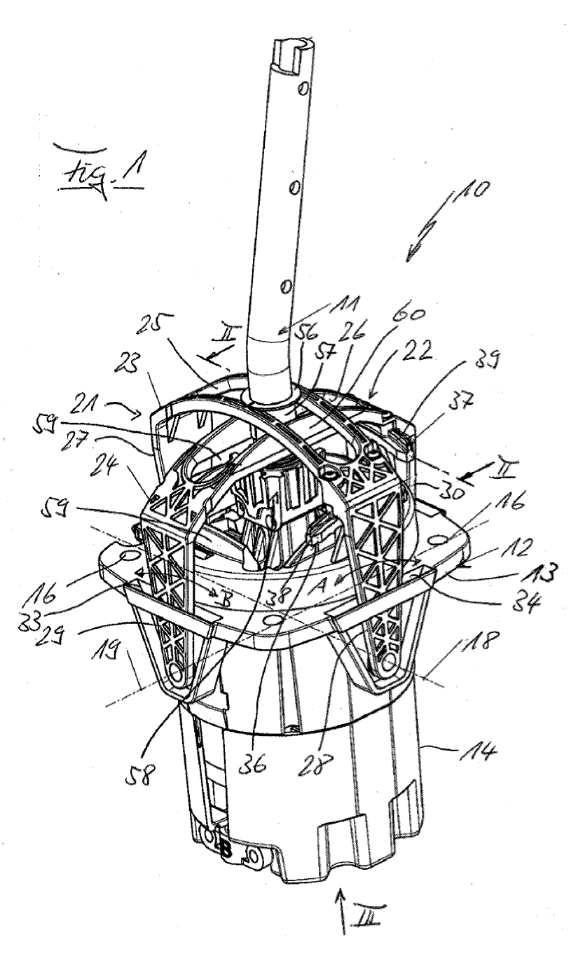

The device 10 as shown in the figures may be used for controlling machines and vehicles, particularly construction machines, cranes, agricultural vehicles, and the like. The device 10 may incorporate the implementation of additional tactile feedback for the operator on the respective operating path or process path of the device 10. The design of the device 10 may be similar to that of a joystick which may be moved back and forth, according to the represented exemplary embodiment, in two mutually perpendicular directions along the double arrows A and B as shown in FIG. 1, and in corresponding combined directions.

The device 10 may include a gimbal mounted control lever 11 such that it is movable, either by pivoting or swiveling, in an X-Y plane in a console 12. The console 12 may include a console plate 13 which forms an installing plane of the device 10 in a component of the machine or of the vehicle to be controlled, and on whose bottom side a console housing 14 may receive the mentioned gimbal 15 of the control lever 11, and a sensor system as well as an evaluation electronic system for determining a position of the control lever 11. The console plate 13 may further include various recesses 16 for attaching the console 12 to the machine or vehicle to be controlled.

The control lever 11 may be guided in an area that is turned away from the gimbal 15, above the console plate 13, by two holders 21 and 22, which may be attached such that they may move or swivel perpendicularly to each other. The holders 21 and 22 may be moveably attached (e.g., swivelably attached) about perpendicularly crossing axes 18 and 19, which may be located beneath the installation plane. Each holder 21, 22 may be U shaped; i.e., it has the shape of an upside down U whose curved area 23 or 24 is provided each with a longitudinal slit 25, 26 through which the control lever 11 may penetrate and in which the control lever 11 may be guided. The two curved areas 23 and 24 may be located one above or under the other in the axial direction of the control lever 11, and each curved area may be delimited by flat brackets 27 and 28, or 29 and 30. The two holders 21 and 22 may be formed as a single piece. The lateral brackets 27 and 28 may be movably attached (e.g., swivelably attached) about the axis 18, and the lateral brackets 29 and 30 may be moveably attached (e.g., swivelably attached) in the direction of the double arrow A or B about the axis 19 as shown in FIG. 1. The two axes 18 and 19 may be located beneath the console plate 13 or the installation plane, and the two axes may cross in the same plane. For this purpose, the lateral brackets 27, 28, 29 and 30 may be introduced into the pockets 33 or 34 whose inlet is in the consoled plate 13, and which extend along the console housing 14 beneath the console plate 13. Thus, depending on the deflection of the control lever 11, the holders 21 and/or 22 may move about their axis (axes) 18 and/or 19.

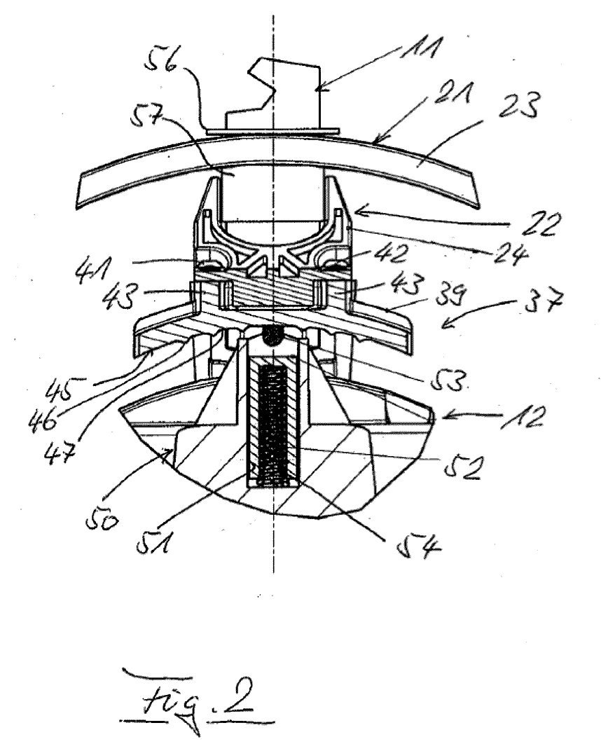

Furthermore, as shown in FIG. 1, each holder 21 and 22 may include, at a transition from the curved brackets 23 or 24 to one of the lateral brackets 27 and 28, or 29 and 30, with a mechanical device 36 or 37. The mechanical device 36 or 37 may include force modifying points or areas that may be detected by tactile means, of which the mechanical device 37 on the holder 22 is shown in greater detail in the enlarged representation in FIG. 2.

The mechanical device 36 may include a curved track element 38 (as shown in FIG. 1), and the mechanical device 37 may possess a curved track element 39 (as shown in both FIGS. 1 and 2). The two curved track elements 38 and 39 may be gimbal mounted at the end of the curved bracket 23 or 24 facing the lateral bracket 27 or the lateral bracket 29, namely with, for example, screws 41, 42, in such a way that they may be replaced if needed. For this purpose, the curved track elements 38 and 39 may include attachment means 43 (as shown in FIG. 2), which are used to center the track elements 38, 39 in the holder 21 or 22.

As shown in FIG. 2, the curved track element 39 of the mechanical device 37 may be included at its bottom side with a circular track 45 at its bottom side having axis 19, and whose contour 46 is provided over the arc of a circle with several force modifying points or areas 47, such as, for example, radially inward protruding bulges (lobes), recesses (groove), wedge shaped track sections or similar features, which can be designed identically or differently in such a way that they may modify the force exertion of contour 46 in both movement directions (e.g., in both the X and Y axes), with regard both to the design and the number of points or areas 47.

Furthermore, the mechanical device 37 (and also the mechanical device 36) may include a pressure element 50 which may be fixedly held to the console plate 13, and which may include a recess bore 51 for a compression spring 52 and, turned away from the latter, with a pusher 53, for example, in the shape of a roller or sphere, which is applied, under spring load from the compression spring 52, to the contour 46 of the circular track 45 which may further include force modifying points or areas 47. The compression spring 52 for the pressure element 50 may be supported in a blind bore 54 of the pressure element 50 or of the console plate 13.

In the movement of the control lever 11, for example, in one of the directions of the double arrow B, the pusher 53 may reach, along a rest or start position 49, a first lobe 47, which may represent a tactile pressure point in this movement direction, which should be overcome by an increased operating force, resulting in the pusher 53 being deflected radially against the compression spring 52. Behind the first lobe 47, the pusher 53 may reach a first position 47, which may be transmitted by tactile means to the operator due to a change in pressure application on the control lever 11. In the first position, for example, a certain drive speed of a component of the machine or the vehicle may be determined by the position of the control lever 11. The operator, by continuing to consciously apply movement pressure to the control lever 11, may move the control lever out of this position in one or the other direction.

It should be noted that the number and arrangement of force modifying points or areas 47 that may be detected by tactile means, along the contour 46 of the circular track 45 in the case of a curved track element 39 and in the case of a curved track element 38 of the respective mechanical device 37, 36, may be identical or different, wherein a different arrangement may be represented overall on the circular track or only as a function of direction. The operator may experience a detectable, opposing resistance due to the counter pressure of the pusher 53 during deflection such that a tactile positional feedback is felt by the operator. The tactile pressure points or areas may result in force modifications with special characteristics, optionally up to and including locking the control lever 11.

According to FIGS. 1 and 2, the control lever 11 may be fitted with a sleeve 57 made of plastic, for example, which may include a radial margin 56 which may be guided, via a guide sleeve, in the longitudinal slits 25 and 26 of the two holders 21 and 22.

Moreover, the device may include an abutment element 58, shown in FIG. 1 in an approximately cubic shape, which may be penetrated by the control lever 11, and which may be arranged between the lower holder 22 and the installing plane 13 of the console 12. Movement delimiting elements 59 may be associated with the abutment element 58, for example, in each direction, and may be arranged in the form of bars that are fixed on the console plate 13, in each case close to the lateral brackets 27, 28, 29 and 30 of the holder 21 and 22.

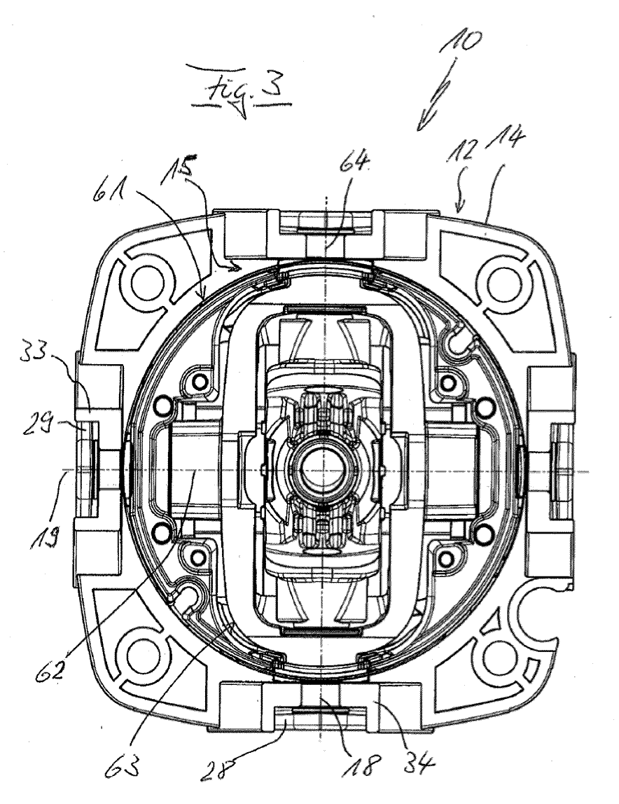

FIG. 3 shows the gimbal 15 for moving the control lever 11 in the X-Y plane. This gimbal 15 may possess an external element 61 which may be movable (e.g., swivelable) about an axis 62, and an internal element 63 which may be movable (e.g., swivelable) about an axis 64 that is perpendicular to the axis 62. The two intersecting gimbal axes 62 and 64 may be positioned in the same plane as the two intersecting axes 18 and 19 of the crossing holders 21 and 22. FIG. 3 shows the respective parts of the axes 18 and 19 as well as 62 and 64, each of which may be located in the same shared plane. In other words, the parts of the axis 18 located outside may be located in an extension of the parts of the axis 62, and the two parts of the axis 19 that are located outside may lie in the extension of the parts of the axis 64.

Additionally, FIG. 1 shows a material strengthening 60 on the holder 22, which may be positioned on a longitudinal side of the curved bracket 24, such that an excessive pressing of the control lever 11 in this one direction along the double arrow B may not result in damage to the holder 22 or to its longitudinal slit 26.

It should be noted that the gimbal elements 61 and 63 may be further equipped with springs in both movement directions. The springs may effect a return in the start or zero position of the control lever 11, optionally also by overcoming the tactile pressure points.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A control device comprising:
a control lever;
a fixed console upon which the control lever is movably mounted about at least two intersecting axes;
a plurality of crossing holders mounted to the fixed console, each crossing holder having a longitudinal slit for guiding the control lever; and
a mechanical device having force modifying points configured to be detected by tactile means during any movement of the control lever, wherein the mechanical device is positioned between the fixed console and the crossing holders, and above an installing plane of the fixed console, and wherein the intersecting axes of the crossing holders pass below an installation plane of the fixed console.

2. The control device of claim 1, wherein the mechanical device is positioned on a lateral area of the crossing holders.

3. The control device of claim 2, wherein the crossing holders are U shaped and the mechanical device is positioned at a transition between a bent brackets mounted about the longitudinal slit and a plurality of flat brackets, wherein the flat brackets are connected to each intersecting axis at each end side of the intersecting axis.

4. The control device of claim 3, further comprising a locking device including a track element mounted to at least one crossing holder, and a pressure element which is mounted to the fixed console and positioned to press against the track element.

5. The control device of claim 4, wherein a bottom side of the track element comprises a pressure element and a track that runs about a swivel axis in the shape of an arc, and wherein the pressure element comprises a contour that modifies any force exerted on the control lever.

6. The control device of claim 5, wherein the track element is detachably mounted on at least one of the crossing holders.

7. The control device of claim 6, wherein the contour is designed either identically or differently in two relative movement directions between the track and the pressure element such that varying pressure is exerted on the control lever during movement of the control lever.

8. The control device of claim 7, wherein the pressure element comprises a pusher that is pre-stressed under spring load against the track, and wherein the pusher is spherical or roller shaped.

9. The control device of claim 8, wherein the crossing holders are positioned in a pocket of the fixed console extending downward beneath the installation plane.

10. The control device of claim 9, further comprising an abutment element positioned on the fixed console between the crossing holders such that the control lever has a limited amount of fixed movement on a top side of the fixed console.

11. The control device of claim 10, characterized in that at least one of the crossing members comprises a reinforcement bracket.

12. The control device of claim 11, wherein the control lever comprises a slide bush that slides into the longitudinal slits of one of the crossing holders, and reduces any friction and noise between the control lever and the two crossing holders.

13. The control device of claim 12, wherein the control lever is gimbal mounted in an area beneath the installation plane of the fixed console, wherein any intersecting axes of the gimbal, which cross in a common plane, are located in the same plane as the intersecting axes of the crossing holders.

14. The control device of claim 13, wherein various elements of the gimbal are movable vertically toward each other and are resettable under spring load in their movements.

15. The control device of claim 14, further comprising a sensor system for an evaluation unit positioned at a lower internal end of the control lever in the console housing.
